(19) United States
(12) Patent Application Publication
(10) Pub. No.: US 2026/0100926 A1
(43) Pub. Date: Apr. 9, 2026

(54) System and method for attaching voice recordings and voice symbols to content items within messaging applications

(71) Applicant: Yotam Zakai, Ramat Gan (IL)

(72) Inventor: Yotam Zakai, Ramat Gan (IL)

(21) Appl. No.: 19/415,830

(22) Filed: Dec. 11, 2025

Related U.S. Application Data
(63) Continuation-in-part of application No. 18/760,407, filed on Jul. 1, 2024.
(63) Continuation-in-part of application No. 18/766,670, filed on Jul. 9, 2024.

(51) Int. Cl. H04L 51/10; G06F 3/04817; G06F 3/04842

(52) U.S. Cl. CPC H04L 51/10; G06F 3/04817; G06F 3/04842

(57) ABSTRACT

The present invention refers to a system and a method for attaching a voice recording to a content item displayed within a messaging application and attaching a voice symbol to the graphical presentation of the content item that includes the steps of displaying the graphical presentation on the user's mobile device, recording a voice recording to be attached to the content item, configuring the content item together with the voice recording as a unified item configured to be sent or forwarded as a single item within the messaging application, displaying a voice symbol with the graphical presentation that is configured to indicate that the first voice recording associated with the content item is playable, sending the unified item to the mobile device of the contact, displaying the received unified item within the chat on the contact's mobile device, playing the voice recording on the contact's mobile device.

### RELATED APPLICATIONS

This application is a continuation in part of U.S. patent application Ser. No. 18/766,670 filed on Jul. 9, 2024 and of U.S. patent application Ser. No. 18/760,407 filed on Jul. 1, 2024.

### TECHNICAL FIELD

The present invention refers to a system and a method for attaching voice recordings and adding voice symbols to a graphical presentation of content items within messaging applications.

### BACKGROUND ART

There is a constant need to improve the communication between users in messaging apps and to increase the possibilities of emotional expressions sent over the chats, and the present invention discloses systems for enhancing the options to communicate over messaging apps. It is common now to send files about work matters through chats in communication apps, and regularly, people make written comments (text messages) about these files or about their content. The present invention discloses a system that significantly facilitates communication between people in this regard.

### DESCRIPTION OF THE DRAWINGS

The intention of the drawings attached to the application is not to limit the scope of the invention and its application. The drawings are intended only to illustrate the invention, and they constitute only one of its many possible implementations.

FIG. 1 illustrates the system (500).

FIG. 2 illustrates the user's mobile device (507).

FIG. 3 illustrates the contact's mobile device (508).

FIG. 4A is a schematic illustration of the user's smartphone.

FIG. 4B is a schematic illustration of the contact's smartphone.

FIG. 5 is a schematic illustration of the user's smartphone with stickers keyboard.

FIG. 6 is a schematic illustration of the system (100).

FIG. 7 is a schematic illustration of the system (200).

FIG. 8 is a schematic illustration of the system (300).

FIG. 9 is a schematic illustration of the user's computing device (1100).

FIG. 10 is a schematic illustration of the contact's computing device (1200).

### THE INVENTION

The main objective of the present invention is to provide a system (500) and a computer-implemented method for attaching a voice recording (501) to a content item (502) displayed within a messaging application (503) and adding a voice symbol (504) to a graphical presentation (505) of the content item.

The method includes one or more of the following steps executed by one or more processing devices (506) (and/or processors) on the mobile device (507) of a user and on a mobile device (508) of a contact of the messaging application. The system (500) includes the processing devices (and/or processors) on the mobile device of the user (508) and/or on one or more processing devices (506) on a remote server (550).

Displaying by the processing device of a user's mobile device a graphical presentation of a content item on a screen (509) of the user's mobile device. The contact's mobile device has a screen (510). The content item may be a file sent within the messaging application from the mobile device of the contact and displayed within the chat (511) of the user and the contact, or a sticker (512) selected by the user from a sticker keyboard (513).

Recording, by the user's mobile device, a first voice recording (501A) configured to be attached to the content item. Adding, by the processing device of the user's mobile device, to the graphical presentation of the content item within the chat, a first voice symbol (504A) configured to indicate that the first voice recording associated with the content item is playable upon activation of the first voice symbol. The term “adding” may be placing on or near or next to the graphical presentation of the content item.

Configuring, by the processing device of the user's mobile device, the content item together with the first voice recording as a unified item (514) configured to be sent or forwarded as a single item within the messaging application. Sending the unified item from the user's mobile device to the mobile device of the contact. Receiving, by the contact's mobile device, the unified item sent from the mobile device of the user.

Displaying, by the processing device of the contact's mobile device, the received unified item within the chat, the received unified item comprising the graphical presentation of the content item together with the first voice symbol. The first voice recording is playable on the contact's mobile device upon activation of the first voice symbol, and playing, by the contact's mobile device, the first voice recording in response to an activation of the first voice symbol displayed together with the graphical presentation of the content item.

In another embodiment of the present invention, the method also includes the steps of displaying, by the processing device of the contact's mobile device, the graphical presentation of the content item with the first voice symbol on the screen of the contact's mobile device, recording, by the contact's mobile device, a second voice recording (501B) configured to be attached to the unified content item, attaching, by the processing device of the contact's mobile device, the second voice recording to the unified item, the second voice recording being associated with a second voice symbol (504B) displayed together with the graphical presentation of the content item.

Configuring the unified item such that the first and second voice recordings are individually playable upon activation of their respective voice symbols, and sending, by the contact's mobile device, the unified item including both voice recordings as a single item to one or more recipient chats within the messaging application.

The term “content item” in this disclosure and in the claims means any file or element that can be sent in a chat within a messaging application, such as image files, stickers, GIFs, documents, emojis, links, and other items that can be sent in a chat and that have a graphical presentation when displayed on the screen. The term also encompasses links that have a graphical presentation on the mobile device's screen, regardless of whether the underlying file is stored on the device or on a remote server. The term “mobile device” in this disclosure and in the claims includes any computing device that has a screen and internet connectivity and is capable of running a messaging application, such as smartphones, tablets, laptops, and similar devices. The term “messaging application” in this disclosure and in the claims refers to any software or platform that enables sending messages from a user to a contact, including the sending of files and voice messages.

The term “voice symbol” in this disclosure and in the claims refers to any graphical representation that may serve as an indication that the unified content item displayed on the screen includes a voice recording, such that activating the symbol enables playback of the voice recording. For example, a small triangular icon is commonly used to indicate that tapping it will initiate playback of a voice recording.

In this specification and in the claims, the term “attaching” a voice recording to a content item means that the messaging application forms a unified item in which the content item and the voice recording are handled as one message element. Once attached, the voice recording and the content item are treated by the application in the same operational manner as a standard single file that is sent or forwarded within the messaging application. The unified item is stored, sent, forwarded, and received as a single item. In addition, attaching ensures that the unified item is presented together on the screen, such that the graphical presentation of the content item and the voice symbol indicating the presence of the voice recording are displayed together on the screens in a fixed relationship. The application does not present one without the other.

This guarantees that throughout its lifecycle—creation, sending, forwarding, receiving, display, and playback—the attached voice recording and the content item function as a single, unified item within the messaging application.

The messaging application includes programming instructions that cause the system to process, store, send, and forward the content item together with the attached voice recording as a single unified item. These instructions ensure that the unified item is handled in the same operational manner as a standard file within the messaging application.

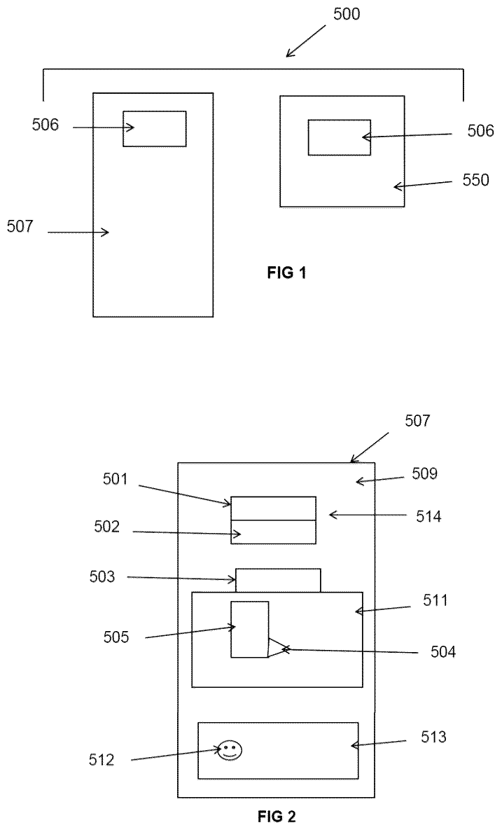

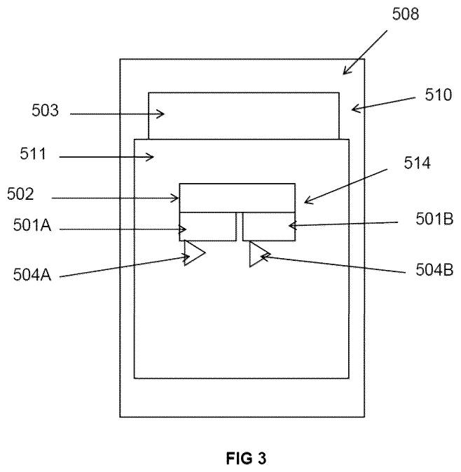

FIG. 1 illustrates the system (500), FIG. 2 illustrates the user's mobile device (507), and FIG. 3 illustrates the contact's mobile device (508).

In this disclosure and in the claims we use expressions as is customary in the field, but for the sake of clarity, we will specify and explain several terms, as follows: the term virtual keyboard (10) means keyboards that are displayed on the touch screens of smartphones for typing text to be sent over a chat. These keyboards may be pre-downloaded in the smartphone by the manufacturers or the suppliers, downloadable by the users, or keyboards that are a part of messaging apps; the term a writing spacebar (11) is the rectangular window in a virtual keyboard or in a messaging app in which the user type or enter text that he wants to send over the chat; the term a panel bar (12) means a row or rows or space of main icons, each of which opens another internal integral keyboard, which can be for example a stickers keyboard, a Gif keyboard, or emoticons keyboard; the term a stickers keyboard (13) means any keyboard that contains stickers, GIFs, emoticons, images or files that are an integral part of the virtual keyboard or an integral part of the messaging app. The term stickers in disclosure and in the claims means stickers, Gifs, emoticons and images that are sent from the keyboard over the chats of the messaging apps.

The main objective of the present invention is to provide a computer system (100) computer system for storing instant pre-prepared sound-sticker messages (101) and for sending a selected instant pre-prepared sound-sticker message (102) over a chat (59) in a messaging app from a user's smartphone (51) to a contact's smartphone (55).

The system comprises a processing device (52) in the user's smartphone that is configured to: Display by the processing device on a touch screen (53) of the user's smartphone a panel bar display (12) that is integrated with a virtual keyboard (10) or with the messaging app. Display by the processing device on the touch screen of the user's smartphone a main sound-sticker icon (104) on the panel bar display. Display by the processing device on the touch screen of the user's smartphone an instant pre-prepared sound-sticker messages keyboard (105) that is integrated with the virtual keyboard (10) or with the messaging app. The instant pre-prepared sound-sticker messages keyboard may be opened when tapping on the main sound-sticker icon (104).

Save by the processing device on the user's smartphone the instant pre-prepared sound-sticker messages in the instant pre-prepared sound-sticker messages keyboard.

The instant pre-prepared sound-sticker messages are files of sound that may be for example MP3 or MP4 combined with a sticker. The sound may be for example music, sound of nature, machines, animals, human voices, or effects of instruments. The term sticker in this regards in this disclosure and the claims means any visual sign or graphic such as icons, stickers, images and animations.

Display by the processing device on the touch screen a plurality of stickers (106) in the instant pre-prepared sound-sticker messages keyboard. Each sticker (106) is linked to an instant pre-prepared sound-sticker message (101) of these instant pre-prepared sound-sticker messages. It is possible and preferable that each sticker will have a unique visual design to enable the user to select the instant pre-prepared sound-sticker message he wants to send over the chat, and also to enable to fit the sound to the visual graphic of the sticker to express the feelings of the sender.

Select by the processing device the selected instant pre-prepared sound-sticker message upon a tapping action on a sticker (1061) in the instant pre-prepared sound-sticker messages keyboard that is linked to the selected instant pre-prepared sound-sticker message (102).

Upload by the processing device the selected instant pre-prepared sound-sticker message (102) (directly or indirectly) into the chat (59). This upload configured to cause the user's smartphone to send the selected instant pre-prepared sound-sticker message to the contact's smartphone over the chat. Alternatively, upload by the processing device the selected instant pre-prepared sound-sticker message into the writing spacebar (11) of the messaging app or of the virtual keyboard that enables the user to send the selected instant pre-prepared sound-sticker message to the contact's smartphone over the chat. The system (100) may further include a play symbol (400) on the sound-sticker message to notify that this sound-sticker includes sound. It is preferable that instant pre-prepared sound-sticker messages will be displayed on the screen of the smartphone as a sticker with the play symbol (400).

Another embodiment of the present invention refers to a computer system (200) for creating a combined voice-sticker message (201) that is designed to be sent over the chat in the messaging app from the user's smartphone to the contact's smartphone.

The system (200) comprises the processing device in the user's smartphone that is configured to: Display by the processing device on the touch screen of the user's smartphone panel bar display that is integrated with the virtual keyboard or with the messaging app. Display by the processing device on the touch screen a main stickers icon (14) on the panel bar display. Display by the processing device on the touch screen the stickers keyboard (13) that is integrated with the virtual keyboard or with the messaging app. Display by the processing device on the touch screen a plurality of stickers (15) in the stickers keyboard. Display by the processing device on the touch screen a recording-combining button (202) that is configured to record a voice message and to combine the recorded voice message with a selected sticker (203) for creating the combined voice-sticker message (201). It is possible and preferably that each sticker comprises the recording-combining button that is configured to record the voice message and to combine the recorded voice message with the selected sticker used to record the voice message for creating the combined voice-sticker message.

Upload by the processing device the combined voice-sticker message directly into the chat. This upload constitutes an action of sending the combined voice-sticker message to the contact's smartphone over the chat. Alternatively, upload by the processing device the combined voice-sticker message into the writing spacebar of the messaging app enables the user to send the selected combined voice-sticker message to the contact's smartphone over the chat. The system (200) may further include a play symbol (400) on the combined message (201) to notify that this sticker is also a voice message.

It is possible and preferable that each of the plurality of stickers comprises the recording-combining button that is designed to be activated upon a first style tapping action, and also comprises a sticker plain send button (204) that is designed to be activated upon a second style tapping action (different of the first style). By that, each sticker can be sent over the chat upon the first style taping action and it is sent as a sticker (as a sticker without sound), and in addition to that, each sticker is designed to be sent over the chat as a part of the combined sticker-voice-message upon using second style taping action. For example, the user can touch the sticker and it will be sent over the chat or to touch it long touch to record the voice message and to make the combining and sending steps.

Another embodiment of the present invention refers to a computer system (300) for creating a combined voice-image message (301) that is designed to be sent over the chat in the messaging app from the user's smartphone to the contact's smartphone.

The system (300) comprises the processing device in the user's smartphone that is configured to: Display by the processing device on the touch screen of the user's smartphone a selected image (302). Display by the processing device on the touch screen a recording-combining button (303) that is configured to record the voice message and to combine the recorded voice message with the selected image for creating the combined voice-image message. Upload by the processing device the combined voice-image message into the chat. The upload constitutes an action of sending the combined voice-image message to the contact's smartphone over the chat.

The system (300) may further include a play symbol (400) on the combined message (301) to notify that this sticker is also a voice message.

The buttons may be visible on the screen of the user's smartphone or may be invisible; one button may be used to process the functions of all those buttons. The term “displaying” with regard to these buttons is illustrative. The use of these buttons may be done by tapping on or touching a graphic symbol on the screen of the smartphone or physical buttons on it, by tapping on or touching the screen of the smartphone in a certain way, by tilting the smartphone in a certain way, or in any other way that can be used to select an option or to execute an action on mobile devices such smartphones with touch screens and the term tapping in this disclosure and in the claims means any way of activating such buttons. The term ‘displaying a button’ in this disclosure and in the claims means: providing the user with the option to execute the actions that these ‘buttons’ are designed to execute or perform, even though the user's eye doesn't really see a button or anything on the screen. For example, placing three fingers on the screen and quickly sliding them down can cause some action on the device. In addition to that, it is possible that one button will be used to function as two or more of the buttons.

The systems of the present invention can be realized and performed through a feature that the operators of messaging apps can add to their messaging apps by updating their apps for adding the instant pre-prepared sound message keyboard, and/or for enabling to combine a voice message with stickers or images, or by smartphones' manufacturers by upgrading the operations system, or by virtual keyboards providers.

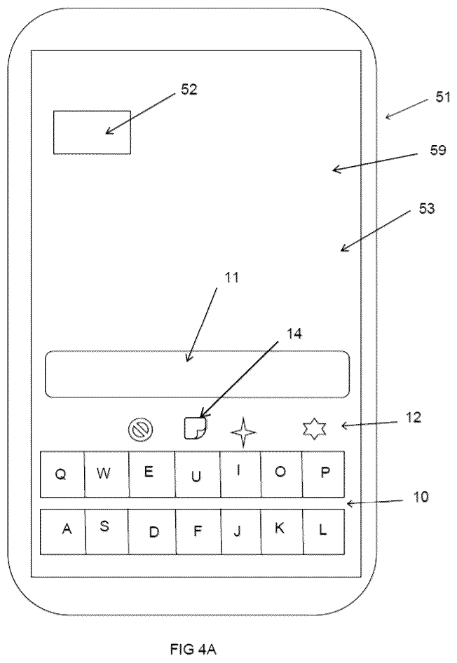

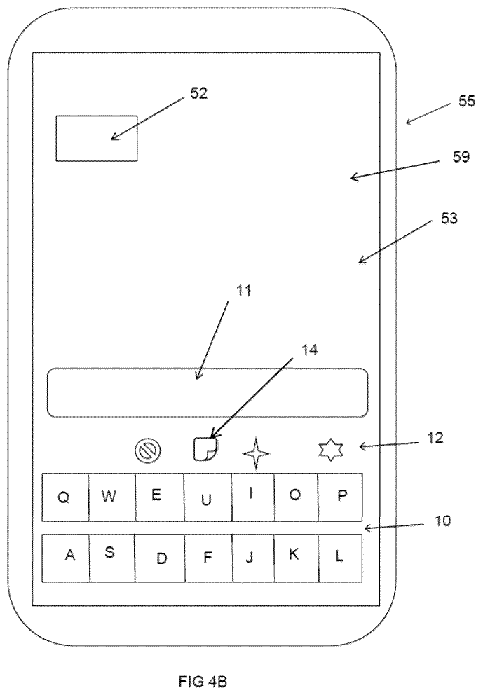

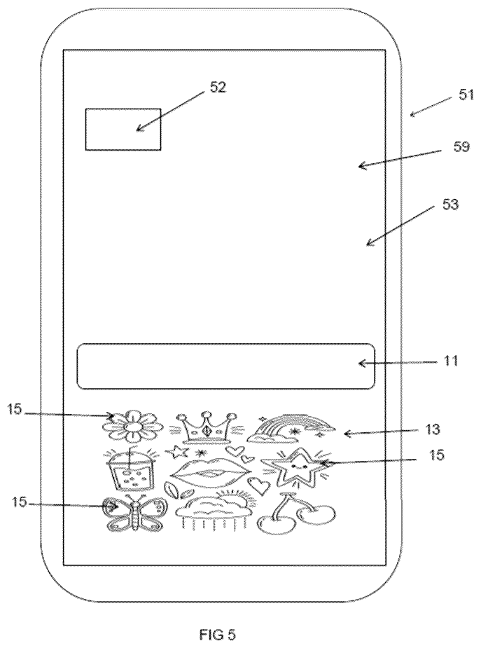

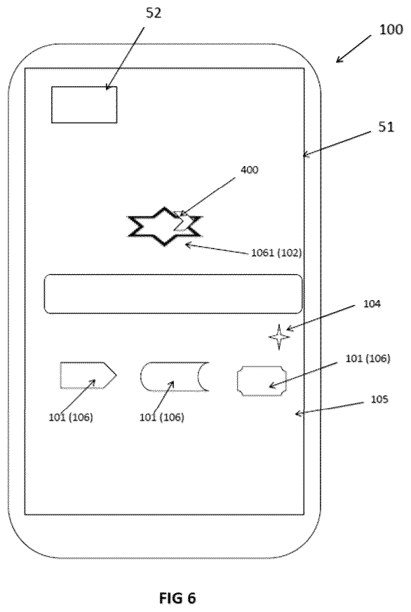

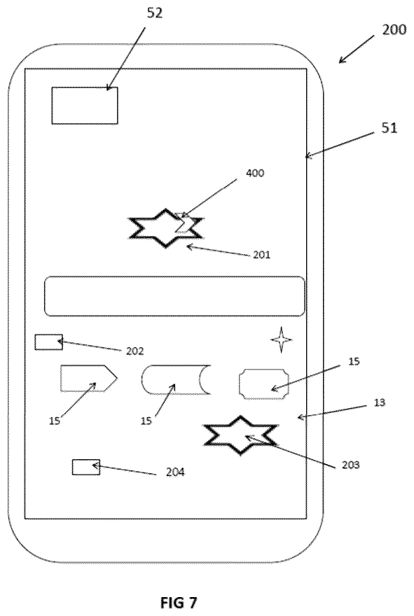

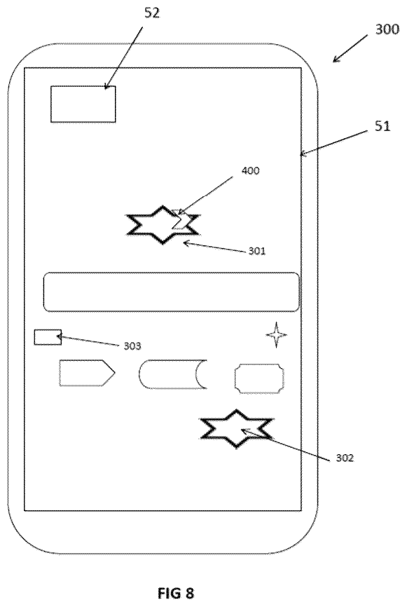

The invention meets a real and specific need, which is not answered by the present art: to have an instant pre-prepared sound messages keyboard that is integrated with the virtual keyboard or with the messaging app, to save ‘on hand’ the instant pre-prepared sound messages that can be sent immediately, for example, by one or two touches on the screen, and to combine a voice message with stickers and images. FIG. 4A is a schematic illustration of the user's smartphone; FIG. 4B is a schematic illustration of the contact's smartphone (55); FIG. 5 is a schematic illustration of the user's smartphone with the stickers keyboard (13); FIG. 6 is a schematic illustration of the system (100); FIG. 7 is a schematic illustration of the system (200); and FIG. 8 is a schematic illustration of the system (300).

The objective of the present invention is to also to provide a computer system (1000) for creating and sending a file-voice-message (5100) over a chat (2000) in a communication app from a computing device (1100) of a user to a computing device (1200) of a contact. The system (1000) comprises the processing devices (1300) that are running on the computing devices of the user and of the contact. The term computing device refers to any kind of computer with an internet connection, such as a desktop computer, a laptop, a tablet, a smartphone and the like. The term “file” in this disclosure and in the claims means any kind of file that can be sent over chats of communication apps, such as image file types (such as jpeg, png, tif, gif), document file types (such as pdf, docx, xlsx, pptx), audio file types, videos, web file types, and any other kind of files that can be sent over chats in messaging apps.

The computer system is configured to: A. Display, by the processing device in the user's computing device, on a screen (14) of the user's computing device a selected file (1500). The file may be selected by the user from the memory (1600) in his computing device, from the chat (2000), from another chat, from a cloud, or from a browser. The important part in this regard is that the file is displayed (but not necessarily opened) on the screen of the computing device of the user. B. Display, by the processing device of the user's computing device, on the screen of the user's computing device a recording-combining-sending button (5200) that is configured to do the following: to record a voice message (5300), to combine the recorded voice message with the selected file (for creating the combined file-voice message), and to send the combined file-voice message over the chat to the contact's computing device. C. Record, by the processing device in the user's computing device, the voice message, combine the voice message with the selected file and create the combined file-voice message; D. Send, by the processing device in the user's computing device, the combined file-voice message over the chat to the computing device of the contact.

E. Display, by the processing device in the computing device of the contact, the combined file-voice message on a screen (1400) of the contact's computing device. It is possible that the combined file-voice message will be designed to be displayed on the screens of the user and/or of the contact in such a way that the voice message can be played and heard while the selected file is opened and viewed on the screens. F.

The combined file-voice message may further include a graphical symbol (5400) on the combined file-voice message to notify that this file includes a voice message.

The recording-combining-sending button may be visible on the screen of the user's smartphone or may be invisible; one button may be used to process the functions of the recording, the combining and the sending of the combined file-voice message over the chat or two or more buttons. The term “displaying” with regard to these buttons is illustrative. The use of these buttons may be done by tapping on or touching a graphic symbol on the screen of the smartphone or physical buttons on it, by tapping on or touching the screen of the smartphone in a certain way, by tilting the smartphone in a certain way, or in any other way that can be used to select an option or to execute an action on mobile devices such smartphones with touch screens and the term tapping in this disclosure and in the claims means any way of activating such buttons. The term ‘displaying a button’ in this disclosure and in the claims means: providing the user with the option to execute the actions that these ‘buttons’ are designed to execute or perform, even though the user's eye doesn't really see a button or anything on the screen. For example, placing three fingers on the screen and quickly sliding them down can cause some action on the device.

The system of the present invention can be realized and performed through a feature that the operators of communication apps can add to their communication apps by updating their apps to enable the users to combine a voice message with selected files and to send the combined file-voice message over the chat, or by computer entities by upgrading their operations system, or by virtual keyboards providers.

The present invention meets a real and specific need, which is not answered by the present art: to select a file that is displayed on the screen, to record a voice message, to combine the recording voice message with the selected file, and to send the combined file-voice message over the chat.

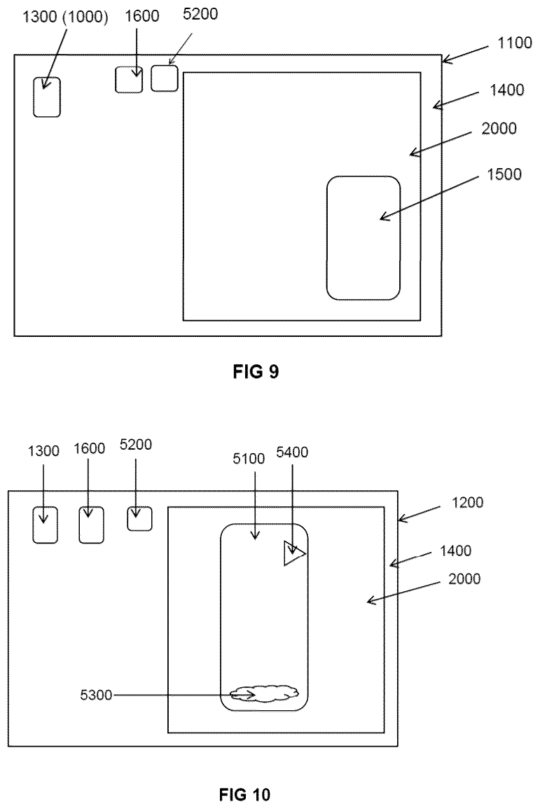

FIG. 9 is a schematic illustration of the user's computing device (1100) and FIG. 10 is a schematic illustration of the contact's computing device (1200).

The application of the present invention can be in a variety of ways: for example, the user selects a file (from the library on the computer or one that is displayed on the screen), presses on the recording-combined-sending button (5200) to make a recording (the voice message) that will be combined with the selected file. After the recording is done, the combined file is displayed on the screen, and the user can click on buttons whose purpose is to send the combined file to the contact via the chat, and there can be several buttons to perform the task, for example: press a “share” button to select the communication application of the intended chat, press a button to select the contact, and then click “send” button to send the combined file over the chat. The term ‘recording-combining-sending button’ may include all these buttons and/or include all these functions and/or a part of them. The route described above is more or less based on the way a file is selected on a smartphone and sent to a contact over a chat in a communication application, and this is for illustration purposes only, and is not intended to limit the scope or the application of the invention. Or for example, the user is in the chat, clicks on the attach file button to be send, directories appear on the screen, the user selects a directory, then selects a file, clicks on the ‘recording-combining-sending button’ button to record the voice message and to combine it with the recorded voice message, then clicks the ‘send’ button. The route described above is more or less based on how users in a chat choose a file to send through the chat.

It is possible from a programming perspective to combine the voice message and the selected file (such as an image, doc, or PDF) to send them together over chats and display them together in a graphical representation. Here's an overview of how this may done: File Combination: first, to bundle the voice message and the selected file together. This step could be achieved by: Packaging into a Container: Using formats like ZIP to combine the audio file and the document/image file. Embedding: Embed the audio file into the document if the document format supports it (e.g., embedding audio in a PDF), but this is optional. Representation: To ensure the files are displayed together: it is possible to add metadata that links the files together. Custom Formats: Create a custom file format or a wrapper that understands both files and displays them accordingly. Transmission: Sending the combined file over chats can be done using standard Protocols: Utilize existing chat protocols that support file attachments (e.g., WhatsApp, Telegram, Slack); or Custom Protocols: Developing a custom protocol if needed. The Display: To display them together in the chat: Custom Client: Develop a custom chat client that knows how to handle the combined file and present it.

Embedded Players: Use embedded players to display documents and play audio files together within the chat application. Sending and Displaying: Sending: Use an API provided by the chat service. Displaying: Modify the chat client to understand the ZIP file and render the audio and document together.

In summary, combining and sending files in the manner described above involves bundling the files, using metadata, and customizing the client for display. This approach can be tailored based on the specific requirements of the chat platform and the capabilities of the chat client.

The term “combine” in the context of the present invention as detailed above and defined in the claims, means, connection or binding or linking of the two files (the file expressing the voice message and the file expressing the selected file) so that they can be sent together, as one sends one file, through the chat. And also, their presentation on the screen, for example in a chat, in such a way that they will appear to the human eye as an integrated, integral thing, for example, that the combined file will be displayed on the screen as today such selected files are displayed on computing screens, accompanied by something graphic that will indicate that it includes one or more voice messages, For example, a PLAY symbol, in the bottom corner of the file.

What we claim is:

1. A computer-implemented method for attaching a voice recording to a content item displayed within a messaging application and a voice symbol to the graphical presentation of the content item, the method comprising:
displaying, by a processing device of a user's mobile device, a graphical presentation of a content item on a screen of the user's mobile device, the content item comprising a file sent within the messaging application from a mobile device of a contact to the user's mobile device and displayed within a chat of the user and the contact, or a sticker selected by the user from a sticker keyboard;
recording, by the user's mobile device, a first voice recording configured to be attached to the content item;
configuring, by the processing device of the user's mobile device, the content item together with the first voice recording as a unified item that is configured to be sent or forwarded as a single item within the messaging application;
displaying, by the processing device of the user's mobile device, a first voice symbol within the chat attached to the graphical presentation of the content item, the first voice symbol is configured to indicate that the first voice recording associated with the content item is playable upon activation of the first voice symbol;
sending, by the user's mobile device, the unified item to the mobile device of the contact;
receiving, by the contact's mobile device, the unified item sent from the mobile device of the user;
displaying, by a processing device of the contact's mobile device, the received unified item within the chat, the received unified item comprising the graphical presentation of the content item together with the first voice symbol, wherein the first voice recording is playable on the contact's mobile device upon activation of the first voice symbol; and
playing, by the contact's mobile device, the first voice recording in response to an activation of the first voice symbol displayed together with the graphical presentation of the content item.

2. The method of claim 1, further comprising:
displaying, by the processing device of the contact's mobile device, the graphical presentation of the content item with the attached first voice symbol on the screen of the contact's mobile device;
recording, by the contact's mobile device, a second voice recording configured to be attached to the unified content item;
attaching, by the processing device of the contact's mobile device, the second voice recording to the unified item, the second voice recording being associated with a second voice symbol displayed with the graphical presentation of the content item;
configuring the unified item such that the first and second voice recordings are individually playable upon activation of their respective voice symbols; and
sending, by the contact's mobile device, the unified item including both voice recordings as a single item to one or more recipient chats within the messaging application.

3. A system for attaching a voice recording to a content item displayed within a messaging application and attaching a voice symbol to a graphical presentation of the content item, the system comprising:
a user's mobile device including a processing device and a memory storing instructions which, when executed by the processing device, cause the user's mobile device to:
display a graphical presentation of a content item within a chat of the messaging application, the content item comprising a file received from a contact or a sticker selected by the user;
record a first voice recording configured to be attached to the content item;
configure the content item together with the first voice recording as a unified item that is configured to be sent or forwarded as a single item within the messaging application;
display a first voice symbol within the chat attached to the graphical presentation of the content item, the first voice symbol indicating that the first voice recording is playable upon activation of the first voice symbol; and
send the unified item to mobile device of the contact;
wherein the system further comprises the contact's mobile device, including a processing device and a memory storing instructions which, when executed, cause the contact's mobile device to:
receive the unified item;
display the unified item within the chat together with the first voice symbol; and
play the first voice recording in response to an activation of the first voice symbol.

4. The system of claim 3, wherein the memory of the contact's mobile device further stores instructions which, when executed by the processing device, cause the contact's mobile device to:
display the graphical presentation of the content item with the attached first voice symbol;
record a second voice recording configured to be attached to the unified item; attach the second voice recording to the unified item, the second voice recording being associated with a second voice symbol displayed with the graphical presentation of the content item;
configure the unified item such that the first and second voice recordings are individually playable upon activation of their respective voice symbols; and
send the unified item, including both voice recordings as a single item, to one or more recipient chats within the messaging application.
